(19) United States
(12) Patent Application Publication
(10) Pub. No.: US 2014/0278886 A1
(43) Pub. Date: Sep. 18, 2014

(54) Systems and Methods of Virtual Marketplace of Reward/Loyalty Points

(71) Applicant: COX COMMUNICATIONS, INC., Atlanta, GA (US)

(72) Inventor: Pujan Roka, Atlanta, GA (US)

(73) Assignee: COX COMMUNICATIONS, INC., Atlanta, GA (US)

(21) Appl. No.: 14/205,419

(22) Filed: Mar. 12, 2014

Related U.S. Application Data
(60) Provisional application No. 61/799,511, filed on Mar. 15, 2013.

(51) Int. Cl. G06Q 30/02

(52) U.S. Cl. CPC G06Q 30/0226
USPC 705/14.27

(57) ABSTRACT

Example embodiments of systems and methods of a virtual marketplace for reward/loyalty points disclosed herein may use geo-fencing to create a marketplace of reward points. The disclosed embodiments may use geo-fencing, coupons, and reward points to draw customers to a target location. Reward points are typically specific to and redeemable at the target location. A customer may use a mobile application to receive location based coupons that are laden with reward points. For example, a customer is walking past a retailer, such as non-limiting examples of a restaurant, a drug store, a grocery store, a department store, and a gas station, among others. In an example embodiment, she carries a location determination device which notifies the system of her geographic location or that her location is within a predetermined distance from a predetermined location.

### CROSS-REFERENCE TO RELATED APPLICATION

This application claims benefit to U.S. provisional patent application Ser. No. 61/799,511, filed on Mar. 15, 2013, which is incorporated by reference herein.

### TECHNICAL FIELD

The present disclosure is generally related to structured marketing programs and, more particularly, is related to loyalty point programs.

### BACKGROUND

Loyalty programs are structured marketing efforts that reward, and therefore encourage, loyal buying behavior—behavior which is potentially beneficial to a business.

In marketing generally and in retailing more specifically, a loyalty card, rewards card, points card, advantage card, or club card is a plastic or paper card, visually similar to a credit card or debit card, that identifies the card holder as a member in a loyalty program. Loyalty cards are a system of the loyalty business model. Cards typically have a barcode or magstripe that can be easily scanned, and some are even chip cards. Small keyring cards (also known as keytags) which serve as key fobs may be used for convenience in carrying and ease of access.

By presenting the card, the purchaser is typically entitled to either a discount on the current purchase, or an allotment of points that can be used for future purchases. Hence, the card is the visible means of implementing a type of what economists call a two-part tariff.

Application forms usually entail agreements by the store concerning customer privacy, typically non-disclosure (by the store) of non-aggregate data about customers. The store may use aggregate data internally (and sometimes externally) as part of its marketing research. These cards can be used to determine, for example, a given customer's favorite brand of beer, or whether he or she is a vegetarian.

Where a customer has provided sufficient identifying information, the loyalty card may also be used to access such information to expedite verification during receipt of checks or dispensing of medical prescription preparations, or for other membership privileges (e.g., access to a club lounge in airports, using a frequent flyer card).

Some major supermarket chains and pharmacies require the cards in order for customers to receive the advertised loyalty price. Many retailers allow accumulation of fuel discounts. Some have tie-ins with airline frequent-flyer programs, and some agree to donate a percentage of sales to a designated charity.

The practice is also common among book and music retailers, from large chains to independent retailers. In some instances, the customer purchases the card and receives a percentage discount on all purchases for a period of time (often one year); in other instances, a customer receives a one-time percentage discount upon reaching a specified purchase level. (For example, a bookseller's loyalty card program might provide a customer with a 10% off coupon once the customer has spent $200 at the bookseller.) Major retailers may offer loyalty programs that offer points redeemable for dollar-amount discounts after accumulating a set number of points along with other discounts from time to time. Many major hotel chains have cards that allow guests to earn either points (redeemable for discounts, future stays or other prizes) or airline miles. All major US airlines also offer rewards credit cards.

Recently, much attention has been paid to the loyalty programs due to companies providing new ways for consumers and businesses to communicate. Loyalty programs permeate retail experiences. There are heretofore unaddressed needs with previous loyalty program solutions.

### SUMMARY

Example embodiments of the present disclosure provide systems of virtual marketplace for reward/loyalty points. Briefly described, in architecture, one example embodiment of the system, among others, can be implemented as follows: a server configured to store loyalty points for a user, the loyalty points awarded by a first retailer for use at the first retailer and exchangeable for use at a second retailer.

Embodiments of the present disclosure can also be viewed as providing methods for virtual marketplace for reward/loyalty points. In this regard, one embodiment of such a method, among others, can be broadly summarized by the following steps: determining a user is within a predetermined distance from a predetermined location; and awarding reward points to the user based on the determination, the loyalty points redeemable at a first retailer and exchangeable for redemption at a second retailer.

### BRIEF DESCRIPTION OF THE DRAWINGS

FIG. 1 is a system diagram of an example embodiment of a location determination system.

FIG. 2 is a system diagram of an example embodiment of a application on a mobile phone.

FIG. 3 is a system diagram of an example embodiment of a geofencing system of awarding loyalty points.

FIG. 4 is a system diagram of an example embodiment of a virtual marketplace.

FIG. 5 is a flow diagram of an example embodiment of a method of virtual marketplace for reward/loyalty points.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

Example embodiments of systems and methods of a virtual marketplace for reward/loyalty points disclosed herein may use geo-fencing to create a marketplace of reward points. The disclosed embodiments may use geo-fencing, coupons, and reward points to draw customers to a target location. Reward points are typically specific to and redeemable at the target location. A customer may use a mobile application to receive location based coupons that are laden with reward points. For example, a customer is walking past Retailer A, such as non-limiting examples of a restaurant, a drug store, a grocery store, a department store, and a gas station, among others. In an example embodiment, she carries a location determination device which notifies the system of her geographic location or that her location is within a predetermined distance from a predetermined location. In an alternative embodiment, facial recognition is used to determine a customer's identity, determine her location and coordinate with her account information. After her location has been determined, she may then receive an alert for a coupon that could be used at Retailer A or a group of retailers.

In an example embodiment, coupons carry reward points specific to that target location, but may also have tie-ins to another location or another retailer. For example, a coupon for Retailer A may carry reward points for Retailer B. When the customer redeems the coupon at Restaurant A, Retailer A enters a code in the app-coupon to unlock reward points for Retailer B. When reward points are redeemed at Retailer B, Retailer B enters a code in the app to mark it as “used.”

In an example embodiment, the customer who has gathered reward points for Retailer B may decide not to use those points at Retailer B. She may use the app and select the utility in the app to find a merchant who is willing to accept Retailer B reward points. In an example embodiment, the app uploads the request to the reward points marketplace.

In an example embodiment, a virtual marketplace comprises a web portal where merchants can log in and view customers with reward points waiting to be accepted. For example, Retailer C may log into the portal and see a customer with 1000 reward points from Retailer B waiting to be accepted. Retailer C may accept the customer reward points and may pay a fee to Retailer B for the transaction. In essence, Retailer C will be paying 1) the customer as credit for reward points and 2) another merchant for the business they are giving up.

Referring now to FIG. 1, customer 120 approaches near or enters retailer 110. Customer 120 has location determining device 130, which may include a cell phone, pager, and an RF ID tag, among others. The reward/loyalty points may be added to her account based on her location, either in retailer 110 or within a predetermined distance from a predetermined location, such as an intersection, an address, or retailer 110.

In an example implementation, as provided in FIG. 2 a customer downloads mobile app 220 onto phone 210 that is enabled with location based advertising. The customer may receive a location based advertising alert that comes with a coupon with reward points. Coupons may be redeemable at Merchant 1 and reward points may be redeemable at Merchant 2, in a non-limiting example. In an example implementation, the customer redeems the coupon at Merchant 1. Merchant 1 may unlock the reward points for Merchant 2 based on the redemption of the coupon. Customer may then redeem reward points at Merchant 2, or the customer may request a new merchant (Merchant 3) for use of the accumulated reward points in the rewards marketplace. The customer request may be sent to the marketplace queue. Merchant 3 may accept the request from the customer.

In an example embodiment, Merchant 3 is able to view reward points and identify Merchant 2 on app 220. Merchant 3 may pay a percentage of the monetary value of reward points to Merchant 2 (dependent on a previously contracted schedule, for example). Reward points may now be transferred to Merchant 3 and customer redeems reward points at Merchant 3. Merchant 3 marks reward points as “used” at checkout.

In an example embodiment, the reward points are based on a location of the user as provided in FIG. 3. Some mobile applications collect reward points for a user based on what the user does on her phone. The smart phone is aware of the user location by GPS technology or other location determination means. So, if the user happens to walk into Retailer 310, for example, she starts collecting reward points simply based on her presence in store. For example, if a user walk into Retailer 310, she receives 500 points just for walking inside Retailer 310. If she accumulates 5,000 or 50,000 Points, for example, then there may be an arrangement with Retailer 310 that offers her gift cards. She may also be eligible for rewards points for a retailer within geographic radius 330 that will offer coupons or reward points towards the target business. Geofence 320 sets a circumference of a predetermined distance from a predetermined location within which retailers exist for which the points are awarded.

Most loyalty points are targeted toward one merchant. As provided in FIG. 4, the systems and methods of virtual marketplace for reward/loyalty points disclosed herein create an open marketplace of loyalty points with bucket 410. Customers can not only accumulate loyalty points, but merchants such as Retailer 420 and Retailer 430 can also earn business by buying back loyalty points from competing merchants. Buying and selling of loyalty points between Retailers 420 and 430 into and out of bucket 410 of a particular customer gives consumers more power over their usage. For instance, a consumer may use Delta Airlines loyalty points to buy a washing machine at Sears.

With the systems and methods of virtual marketplace of reward/loyalty points disclosed herein, if the user accumulates 50,000 reward points in bucket 410, for example, at Retailer 420 but does not want to use them at Retailer 420, she can create a pool of reward points that other vendors can compete for.

FIG. 5 provides flowchart 500 of an example embodiment of a method of virtual marketplace of reward/loyalty points as disclosed herein. In block 510, the user is determined to be within a predetermined distance from a predetermined location. In block 520, loyalty points are awarded to the user based on the determination, the loyalty points redeemable at a first retailer and exchangeable for redemption at a second retailer.

Although, a smart phone is a commonly used device to implement the systems and methods disclosed herein, any device that can register location and communicate with a rewards marketplace server is acceptable. Geofencing is just one way to accomplish the location part of the disclosure.

The systems and methods disclosed herein establish a marketplace for reward points. If a user collects reward points at Retailer A, Retailer B can attract those Retailer A customers to redeem Retailer A reward points at Retailer B. The reward points may be used anywhere that accepts valid loyalty points according to the system and methods disclosed herein.

The flow chart of FIG. 5 shows the architecture, functionality, and operation of a possible implementation of the method of virtual marketplace. In this regard, each block represents a module, segment, or portion of code, which comprises one or more executable instructions for implementing the specified logical function(s). It should also be noted that in some alternative implementations, the functions noted in the blocks may occur out of the order noted in FIG. 5. For example, two blocks shown in succession in FIG. 5 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

The logic of the example embodiment(s) can be implemented in hardware, software, firmware, or a combination thereof. In example embodiments, the logic is implemented in software or firmware that is stored in a memory and that is executed by a suitable instruction execution system. If implemented in hardware, as in an alternative embodiment, the logic can be implemented with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. In addition, the scope of the present disclosure includes embodying the functionality of the example embodiments disclosed herein in logic embodied in hardware or software-configured mediums.

Software embodiments, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, or communicate the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium would include the following: a portable computer diskette (magnetic), a random access memory (RAM) (electronic), a read-only memory (ROM) (electronic), an erasable programmable read-only memory (EPROM or Flash memory) (electronic), and a portable compact disc read-only memory (CDROM) (optical). In addition, the scope of the present disclosure includes embodying the functionality of the example embodiments of the present disclosure in logic embodied in hardware or software-configured mediums.

Although the present invention has been described in detail, it should be understood that various changes, substitutions and alterations can be made thereto without departing from the spirit and scope of the invention as defined by the appended claims.

Therefore, at least the following is claimed:

1. A system comprising:
a server configured to store loyalty points for a user, the loyalty points awarded by a first retailer for use at the first retailer and exchangeable for use at a second retailer.

2. The system of claim 1, wherein the loyalty points are rewarded based on the user being within a predetermined distance from a predetermined location.

3. The system of claim 1, wherein when the user redeems loyalty points at the first retailer, loyalty points are awarded for the second retailer.

4. The system of claim 3, wherein the second retailer is one of a plurality of retailers within a predetermined distance from the first retailer.

5. The system of claim 1, wherein the server is further configured to provide a portal for retailers to exchange responsibility of reward points with other retailers.

6. The system of claim 5, wherein the second retailer purchases responsibility of loyalty points from the first retailer.

7. The system of claim 5, wherein the exchange is based on a request of the user.

8. A method comprising:
determining a user is within a predetermined distance from a predetermined location; and
awarding reward points to the user based on the determination, the loyalty points redeemable at a first retailer and exchangeable for redemption at a second retailer.

9. The method of claim 8, further comprising awarding loyalty points at the second retailer when the user redeems the loyalty points at the first retailer.

10. The method of claim 9, wherein the second retailer is one of a plurality of retailers within a predetermined distance from the first retailer.

11. The method of claim 8, further comprising exchanging responsibility for loyalty points from the first retailer to the second retailer.

12. The method of claim 11, further comprising the second retailer purchasing responsibility of loyalty points from the first retailer.

13. The method of claim 11, wherein the exchange is based on a request of the user.

14. A computer readable medium comprising instructions for performing steps, the instructions comprising:
determining a user is within a predetermined distance from a predetermined location; and
awarding reward points to the user based on the determination, the loyalty points redeemable at a first retailer and exchangeable for redemption at a second retailer.

15. The computer readable medium of claim 14, further comprising instructions for awarding loyalty points at the second retailer when the user redeems the loyalty points at the first retailer.

16. The computer readable medium of claim 15, wherein the second retailer is one of a plurality of retailers within a predetermined distance from the first retailer.

17. The computer readable medium of claim 14, further comprising instructions for exchanging responsibility for loyalty points from the first retailer to the second retailer.

18. The computer readable medium of claim 17, further comprising instructions for the second retailer purchasing responsibility of loyalty points from the first retailer.

19. The computer readable medium of claim 17, wherein the exchange is based on a request of the user
